(19) United States
(12) Patent Application Publication
(10) Pub. No.: US 2026/0203768 A1
(43) Pub. Date: Jul. 16, 2026

(54) EXTENDABLE ENGINE SERVICE COVERAGE PRODUCT AND METHOD

(71) Applicant: RPM INDUSTRIES, LLC, Washington, PA (US)

(72) Inventor: John K. Apostolides, Wexford, PA (US)

(21) Appl. No.: 19/566,632

(22) Filed: Mar. 13, 2026

Related U.S. Application Data
(63) Continuation of application No. 17/401,016, filed on Aug. 12, 2021, now abandoned.
(60) Provisional application No. 63/064,816, filed on Aug. 12, 2020.

(51) Int. Cl. G06Q 30/012; G06Q 10/20

(52) U.S. Cl. CPC G06Q 30/012; G06Q 10/20

(57) ABSTRACT

A method of providing extendable service coverage for an engine of a machine. The method includes executing a qualified maintenance agreement, installing an apparatus on the engine, utilizing the apparatus to perform a fluid service associated with the engine, and performing all services listed in the qualified maintenance agreement.

### CROSS-REFERENCE TO RELATED APPLICATIONS

This application claims the benefit under 35 U.S.C. § 120 of the earlier filing date of U.S. Non-Provisional Ser. No. 17/401,016 filed on Aug. 12, 2021, titled EXTENDABLE ENGINE WARRANTY PRODUCT, which claimed the benefit under 35 U.S.C. § 119(e) of the earlier filing date of U.S. Provisional Ser. No. 63/064,816 filed on Aug. 12, 2020, titled EXTENDABLE ENGINE WARRANTY PRODUCT, the contents of which are hereby incorporated by reference in their entirety.

### BACKGROUND

This application discloses an invention which is related, generally and in various aspects, to an extendable engine service coverage product and method.

It is common for manufacturers to provide a warranty for the engines which they manufacture. For a given manufacturer, the warranty typically limits the coverage to a set period of time (e.g., one year, two years, three years) from the purchase/delivery of the machine, a number of miles driven by a vehicle associated with the engine, a number of hours the engine is operated (e.g., 2,000 hours, 4,000 hours, 6,000 hours), etc. For example, for a large earth-moving machine, the engine warranty is typically for three years or 6,000 hours of engine operation, whichever occurs first. If a customer wishes to secure an engine warranty for a period longer than the coverage period set forth in the terms of the manufacturer's warranty, in certain instances the customer is able to secure an extended engine warranty offered by the manufacturer or a third-party provider. However, in known extended engine warranties, the customer is required to pay the full cost of the extended engine warranty in advance (e.g., approximately $15,000-$25,000 for a three year extension of the manufacturer's engine warranty), at the time the machine is purchased, which is typically three years prior to the start of the extended engine warranty period. In addition, the customer is also required to pay and bear the costs associated with all manufacturer recommended maintenance each year, in order to realize the extended engine warranty coverage. For example, where the engine warranty is for three years and the extended engine warranty is for a period of an additional three years, if the manufacturer required maintenance in any of years 1-3 is not performed, the extended engine warranty can be voided, and at least some of the up-front cost of the extended engine warranty can be retained by the manufacturer or the third-party provider.

Such extended engine warranties are generally available for new machines only (not for a used machine), and are not generally transferable to a subsequent owner when the customer sells the machine. Also, although extended engine warranties are offered by some manufacturers or third-party providers for periods past six years from purchase/delivery of the machine (e.g., 7-10 years from purchase/delivery of the machine), such extended engine warranties are much less common, are very expensive, and the number of such extended engine warranties purchased by customers is essentially negligible. As a result, many manufacturers and/or third-party providers only offer extended engine warranties of a limited overall duration.

Although the manufacturer recommended maintenance costs can vary by equipment and manufacturer, such costs generally run on the order of approximately $5,000 $12,000 per year for a given machine. For example, if the extended engine warranty is for a period of an additional three years (or an additional 6,000 hours, whichever occurs first) following the end of the standard engine warranty, the customer is required to pay the full cost of the three year extended engine warranty in advance (e.g., approximately $15,000-$25,000), at the time the machine is purchased, which is typically three years prior to the start of the extended engine warranty period, as well paying the costs associated with all manufacturer recommended maintenance as they arise in each of the six years (years 1-3 of the standard engine warranty and years 4-6 of the extended engine warranty) in order to retain the extended engine warranty coverage. At approximately $5,000-$12,000 per year for a given machine, the cost associated with the manufacturer recommended maintenance costs can vary from approximately $30,000 to $72,000 over the course of the six years.

It is currently estimated that approximately 80% to 85% of new machines are sold with the above-described extended engine warranties of up to three additional years. To address customer budgets and the costs associated with the manufacturer recommend maintenance costs, qualified service providers such as original equipment manufacturer affiliated distributors or dealers (e.g., distributors affiliated with Caterpillar, Volvo, Komatsu, etc.) offer qualified maintenance agreements which place a set price for the manufacturer recommended maintenance costs for a given term. Such qualified maintenance agreements are structured for a typical term of one year or 2,000 hours of engine operation, whichever occurs first, and can be purchased for multiple terms (years or hours). When new machines are sold, and have zero engine hours, customers enroll a high percentage of such new machines into the qualified maintenance agreements, thereby providing the qualified service providers with a predictable source of revenue associated with the machines. However, as the machines age, customers renew a declining percentage of the qualified maintenance agreements each year. After 4,000-5,000 hours of engine operation, nearly 70% of these qualified maintenance agreements expire or are terminated by the customer. Across a market population of all legacy machines, fewer than 10% of the machines which are still being operated remain under such qualified maintenance agreements past 6,000 hours of engine operation. For the qualified service providers, each machine which is not on a qualified maintenance agreement can be thought of as the loss of a predictable source of revenue.

FIG. 1 illustrates a graph showing a historical relationship between qualified maintenance agreement penetration and hours of engine operation of a machine. The graph of FIG. 1 also shows a product support opportunity lost (in terms of currently unrealized revenue) if the “non-covered” machines were bringing in the revenue associated with machines covered by qualified maintenance agreements. In FIG. 1, the horizontal axis is shown in hours of machine engine operation (a machine engine typically needs to be rebuilt at approximately 20,000 hours of operation), the left vertical axis is shown in percentages of machines covered by qualified maintenance agreements, and the right vertical axis is shown in U.S. dollars of unrealized product support aftermarket opportunity. For the curve having a left end starting at approximately 2,000 hours of machine engine operation and approximately 75% qualified maintenance agreement penetration, the curve represents historic qualified maintenance agreement penetrations for qualified service providers, and shows the percentage qualified maintenance agreement penetration decreases as the machine engine hours increase. This curve may be referred to as the historic qualified maintenance agreement penetration curve. For the curve having a left end starting at approximately 2,000 hours of engine operation and approximately $20,000 of product support aftermarket opportunity, the curve represents the aftermarket product support opportunity available to qualified service providers, and shows the unrealized product support aftermarket opportunity increases as the engine hours of the machine increase. This curve may be referred to as the product support aftermarket opportunity curve. It will be appreciated that as the hours of engine operation increase, the qualified maintenance agreement penetration curve and the product support aftermarket opportunity curve move in opposite directions. Stated differently, as the hours of engine operation increase, the qualified maintenance agreement penetration curve decreases and the product support aftermarket opportunity curve increases. At approximately 5,000 hours of machine engine operation, the two curves intersect, and for each hour of engine operation thereafter, a product support opportunity lost is shown in the area between the two curves.

When machines are new or have low hours (e.g., 0-3,000 hours) of engine operation, the opportunity for qualified service providers to realize revenue for repairs and service work is relatively low, in part due to the fact such machines are often still covered by factory warranties. Once the hours of engine operation reach approximately 5,000 hours of operation (where the product support aftermarket opportunity curve and the qualified maintenance agreement penetration curve intersect), the qualified maintenance agreement penetration curve continues to fall/decrease (as customers cancel or do not renew qualified maintenance agreements) and the product support aftermarket opportunity curve continues to rise/increase, thereby increasing the divergence between the product support aftermarket opportunity curve and the qualified maintenance agreement penetration curve, and by extension, increasing the opportunity for the qualified service providers to realize revenue for repairs and service work. The divergence is represented in FIG. 1 as the shaded area (product support opportunity lost) between the two curves, and is indicative of the divergence between the qualified maintenance agreement opportunity available to the qualified service providers and the actual retention of qualified maintenance agreements for machines.

It is known that when qualified service providers have qualified maintenance agreements in place, and are in routine contact with both the customer and the machine, the likelihood of capturing the opportunity available is much, much higher than when qualified maintenance agreements are not in place. Thus, the loss of such qualified maintenance agreements, just as the machines are entering the maximum opportunity period from approximately 5,000 hours of engine operation up to approximately 20,000 hours of engine operation, represents a critical loss of opportunity to distributors, dealers and other qualified service providers.

Qualified service providers have attempted to address this loss of opportunity by trying to market qualified maintenance agreements with ever increasing terms. In brief, the qualified service providers have tried to keep machines enrolled in qualified maintenance agreements through the relatively high opportunity hours (approximately 4,000-20,000 hours) of engine operation. However, these efforts have met with little success. Approximately 90% of actively working machines are not enrolled in qualified maintenance agreements beyond the 4,000-6,000 hours of engine operation interval. As such qualified maintenance agreements generally run on the order of approximately $4,500-$12,000 per year for a given machine, a customer's acceptance of a six year qualified maintenance agreement typically represents a financial commitment of $27,000 to $72,000 per machine. Given the uncertainties of the business cycle, the inability for certain customers to accept the financial risk, and that customers can operate from a few to thousands of machines annually, it is understandable why approximately 90% of today's actively working machines are not enrolled in qualified maintenance agreements beyond the 4,000-6,000 hours interval of engine operation.

Thus, current extended engine warranties are relatively expensive, require the cost of the extended engine warranty to be paid when the machine is purchased or delivered, are generally limited to new machines only, are not transferable to a subsequent owner of the machine, and are often limited in overall duration.

### BRIEF DESCRIPTION OF THE DRAWINGS

The novel features of the aspects described herein are set forth with particularity in the appended claims. The aspects, however, both as to organization and methods of operation may be better understood by reference to the following description, taken in conjunction with the accompanying drawings.

FIG. 1 illustrates a graph showing a historical relationship between qualified maintenance agreement penetration and hours of engine operation of a machine.

FIG. 2 illustrates an extendable engine service coverage product, in accordance with at least one aspect of the present disclosure.

FIG. 3 illustrates a graph showing the graph of FIG. 1 with a horizontal line added thereto, in accordance with at least one aspect of the present disclosure.

FIG. 4 illustrates a method of providing extendable service coverage for an engine of a machine, in accordance with at least one aspect of the present disclosure.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description of such elements is not provided herein.

In the following detailed description, reference is made to the accompanying drawings, which form a part hereof. In the drawings, similar symbols and reference characters typically identify similar components throughout several views, unless context dictates otherwise. The illustrative aspects described in the detailed description, drawings and claims are not meant to be limiting. Other aspects may be utilized, and other changes may be made, without departing from the scope of the technology described herein.

The following description of certain examples of the technology should not be used to limit its scope. Other examples, features, aspects, embodiments and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

It is further understood that any one or more of the teachings, expressions, aspects, embodiments, examples, etc. described herein may be combined with any one or more of the other teachings, expressions, aspects, embodiments, examples, etc. that are described herein. The following described teachings, expressions, aspects, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Before explaining the various aspects of the extendable engine service coverage product and method in detail, it should be noted that the various aspects disclosed herein are not limited in their application or use to the details of construction and arrangement of parts illustrated in the accompanying drawings and description. Rather, the disclosed aspects may be positioned or incorporated in other aspects, embodiments, variations and modifications thereof, and may be practiced or carried out in various ways. Accordingly, aspects of the extendable engine service coverage product and method disclosed herein are illustrative in nature and are not meant to limit the scope or application thereof. Furthermore, unless otherwise indicated, the terms and expressions employed herein have been chosen for the purpose of describing the aspects for the convenience of the reader and are not meant to limit the scope thereof. In addition, it should be understood that any one or more of the disclosed aspects, expressions of aspects, and/or examples thereof, can be combined with any one or more of the other disclosed aspects, expressions of aspects, and/or examples thereof, without limitation.

Also, in the following description, it is to be understood that terms such as inward, outward, upward, downward, above, below, left, right, interior, exterior and the like are words of convenience and are not to be construed as limiting terms. Terminology used herein is not meant to be limiting insofar as devices described herein, or portions thereof, may be attached or utilized in other orientations. The various aspects will be described in more detail with reference to the drawings.

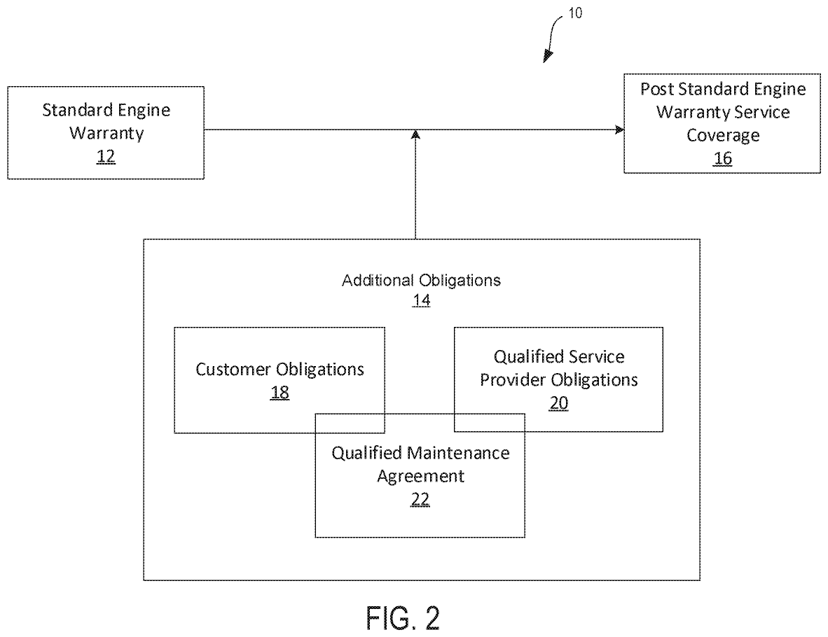

FIG. 2 illustrates an extendable engine service coverage product 10, in accordance with at least one aspect of the present disclosure. The extendable engine service coverage product 10 includes a standard engine warranty 12, additional obligations 14 and post standard engine warranty service coverage 16 (engine service coverage following the expiration of the standard engine warranty 12). According to various aspects, for a new machine, the post standard engine warranty service coverage 16 is generated, created and brought into force by a combination of the standard engine warranty 12 and the additional obligations 14. The post standard engine warranty service coverage 16 can be generated, created and brought into force in increments of time (e.g., one year) since the purchase or delivery of the machine, in increments of hours of engine operation (e.g., 2,000 hours), in increments of miles driven, etc.

According to various aspects, the extendable engine service coverage product 10 provides for catastrophic coverage for the engine, such that when an engine has failed (e.g., cannot run or be easily repaired), the extendable engine service coverage product 10 provides for restoration/rebuilding of the engine. For example, the extendable engine service coverage product 10 covers the following internally lubricated components of the engine: pistons, piston rings, wrist pins, crankshaft, rod and main bearings, camshaft, cam bearings and cam followers, timing chain, timing gears, timing chain tensioners, intake and exhaust valves, valve guides, valve springs and valve retainers, rocker arms, pushrods, lifters, turbocharger rotor/turbine and housing, and water pump, engine block, cylinder heads, and cylinder liners.

Although the extendable engine service coverage product 10 is applicable to any type of engine, for purposes of simplicity the extendable engine service coverage product 10 will be described hereinbelow in the context of an earth-moving machine. As discussed in more detail below, for new machines, the term of the post standard engine warranty service coverage 16 starts at the end of the standard engine warranty 12 and may be extended multiple times, subject to, for example, a limitation on overall years since the machine was purchased or delivered, overall hours of engine operation, overall miles driven, combinations thereof, etc. According to various aspects, each new enrollment in or renewal of the extendable engine service coverage product 10 is valid for one year from the date of enrollment or renewal.

The standard engine warranty 12 has terms which are set by the manufacturer of the engine and/or by the manufacturer of the earth-moving machine. Such terms set forth, for example, the duration of the initial warranty period, the responsibilities of the manufacturer, the responsibilities of the customer (e.g., the owner or the user of the earth-moving machine) and any limitations of the standard engine warranty 12. The duration of the initial warranty period may be expressed in periods of time (e.g., 24 months or 36 months) after the machine was purchased or delivered, an number of hours (e.g., 4,000 hours or 6,000 hours) the engine has been operated, a number of miles the earth-moving machine has been driven, etc.

The responsibilities of the manufacturer may include, for example, (1) materials and labor for repairing or replacing any parts or components needed to correct a defect in material or workmanship, (2) replacing motor oil, transmission fluid, gear oil, steering fluid, filters, coolant and other service items made unusable by the defect and (3) transporting the earth-moving machine to an authorized repair facility if the repair can't be performed on-site. For the materials, the terms of the standard engine warranty 12 may permit the use of new, remanufactured, or manufacturer-approved repaired parts or assembled components needed to correct a defect in material or workmanship. For labor, the terms of the standard engine warranty 12 may cover the cost of reasonable or customary labor needed to correct the given defect, including labor for removal of the defective part (or parts) and installation of the replacement part (or parts). For the transport, the terms of the standard engine warranty 12 may permit towing to the nearest authorized repair facility or reasonable travel expenses to transport the earth-moving machine to the nearest authorized repair facility. Of course, the terms of the standard engine warranty 12 can vary from manufacturer to manufacturer, and thus can be more generous or more limited than the exemplary manufacturer responsibilities set forth above.

The responsibilities of the customer may include, for example, (1) providing proof of ownership of the earth-moving machine, (2) having required maintenance performed on the earth-moving machine; (3) providing timely notice of a warrantable failure and (4) labor costs in excess of reasonable or customary labor costs (e.g., costs for overtime labor). The required maintenance may include, for example, changing engine oil and other fluids in accordance with guidelines set by the manufacturer, replacing filters in accordance with guidelines set by the manufacturer, and using proper fuel, oil, filters, lubricants and coolant in the earth-moving machine in accordance with guidelines set by the manufacturer.

The limitations of the standard engine warranty 12 may remove responsibility from the manufacturer for failures which result from, for example, improper use of the earth-moving machine, use of attachments or accessory items not sold by or approved by the manufacturer, an unreasonable delay in making the earth-moving machine available for repair after defect, or time/miles/hours limits for certain parts or components.

The additional obligations 14 are layered upon, or in addition to, those set forth in the standard engine warranty 12. According to various aspects, the additional obligations 14 include both customer obligations 18 and qualified service provider obligations 20. The additional customer obligations 18 include, for example, (1) executing/entering into and timely paying for a qualified maintenance agreement 22 (e.g., a recommended maintenance agreement, a customer service agreement, a customer value agreement) with a qualified service provider (e.g., a manufacturer or a distributor/dealer associated with the manufacturer) such that all routine maintenance is performed in a timely manner, and (2) having all repairs recommended by the qualified service provider to keep the machine, including the engine of the machine, in good working order completed in a timely manner. Such repairs may be recommended from time to time based on routine inspections performed by the qualified service provider as part of the qualified maintenance agreement 22. The qualified maintenance agreement 22 sets forth the terms and conditions required to keep the extendable engine service coverage product 10 in force and/or eligible for extension or for subsequent extensions, and by extension, the post engine warranty service coverage 16, eligible, in force, and/or eligible for extension or for subsequent extensions. Although, the extendable engine service coverage product 10 may be extended multiple times, the number of extensions may be limited in certain aspects due to a time limit (e.g., 10 years) since the purchase/delivery of the machine, an hour limit (e.g., 20,000 hours) of engine operation, a miles driven limit or combinations thereof which may be applied to limit the overall duration of the extendable engine service coverage product 10. However, even with such a limit, the potential overall duration of the extendable engine service coverage product 10 is still far in excess of traditional extended engine coverages.

The additional qualified service provider obligations 20 include, for example, (1) certifying the engine is eligible for the extendable engine service coverage product 10, (2) performing all services required by/listed in the qualified maintenance agreement 22, and (3) maintaining accurate records of preventive maintenance actions performed, inspections performed, repairs made, customer's adherence to recommended repairs, etc. The services required to be performed by the qualified service provider are set forth by the terms and conditions of the qualified maintenance agreement 22, and include services performed on the engine of the machine. According to various aspects, the qualified maintenance agreement 22 may be offered to the customer in increments such as time (e.g., one year), hours (e.g., two thousand hours) of engine operation, and/or miles driven. Additionally, for intervals of one year, the cost for the services provided by the qualified service provider may be considered to be an annual fee, and may be paid to the qualified service provider on an annual basis.

According to various aspects, the additional qualified service provider obligations 20 further include, for example, (4) installing certain technology/equipment or an apparatus on the engine or the machine, and (5) utilizing such technology/equipment or apparatus to perform services on the engine as set forth in the qualified maintenance agreement 22. Examples of the certain technology/equipment or apparatus include, for example, Purge-Evacuate-Refill-Time Stamp (PERT) technology offered by RPM Industries, LLC, and any of the following fluid removal and replacement apparatuses/services offered by RPM Industries, LLC: (1) QuickFit fluid removal and replacement apparatus; (2) QuickEvac fluid removal and replacement apparatus; (3) MultiVac fluid removal and replacement apparatus; and (4) PERT fluid removal and replacement services. The above-identified technologies and apparatuses/services, which are well known by those skilled in the art, are described in more detail below, and operate to protect engines from excess wear and reduce the risk of engine failure, thereby enabling the qualified service provider to lower the risk of engine failure, and lower the cost incurred by them with performing the services set forth in the qualified maintenance agreement 22. Whereas the cost charged to the customer for a current extended engine warranty runs approximately $5,000-$8,000 per year, the costs incurred by the qualified service provider with performing the services set forth in the qualified maintenance agreement 22 only run approximately $300-$500 per year.

PERT technology makes it possible to not only perform routine maintenance safer, cleaner, and faster, but also document it automatically, all in less than 10 minutes per compartment. The technology includes (1) purging the filters with compressed air so that old filters can be removed and new, clean filters can be installed with no spills, no burns, and absolutely clean and safe, (2) evacuating contaminated fluids such as engine oil, transmission fluid, hydraulic fluid, engine coolant, etc. quickly and cleanly from the respective engine compartments/systems, (3) refilling the respective engine compartments/systems with new fluids (e.g., supplying new oil to the engine via the new, clean filters to filter the new oil and fully pressurize the engine), and (4) timestamping the service to automatically document the maintenance event. All of this can be done with a closed loop system, with no spills, no dripping filters, and with no drain pans or intermediate containers. PERT technology reduces typical times needed to perform preventative maintenance operations, increases technician capacities, and increases machine availability while lowering labor costs.

A QuickFit apparatus includes a valve assembly which is utilized to provide a fluid service for machines serviced at a service/repair facility. With one fitting per compartment (e.g., separate QuickFit apparatuses for engine oil, transmission fluid, hydraulic fluid, engine coolant, etc.), QuickFit apparatuses collectively provide fast and simple fluid management for different fluids for a variety of different machines. A QuickEvac apparatus includes a motor and pump assembly which is utilized to provide a fluid change service for machines serviced in the field, at locations remote from a service/repair facility. The onboard, self-contained capability of the motor and pump assembly enables safer, cleaner and faster changes of a fluid. QuickEvac apparatuses may also include service tools which are utilized/configured to facilitate the evacuation of a fluid from the engine. MultiVac apparatuses are similar to the QuickEvac apparatuses in that the MultiVac apparatuses include a motor and pump assembly, but are different in that MultiVac apparatuses also include a multiple selector valve assembly which is utilized, for machines serviced in the field, at locations remote from a service/repair facility, to provide fluid services to be performed for different fluids (engine oil, transmission fluid, hydraulic fluid, engine coolant, etc.) at different times. Additional information regarding PERT technology, QuickFit apparatuses, QuickEvac apparatuses and MultiVac apparatuses can be found, for example, in U.S. Pat. Nos. 6,216, 732, U.S. Pat. No. 6,708,710, U.S. Pat. No. 7,150,286, U.S. Pat. No. 9,062,575 and U.S. Pat. No. 9,523,296, each assigned to RPM Industries, LLC, the contents of each which are hereby incorporated by reference in their entirety.

As indicated above, the extendable engine service coverage product 10 provides for catastrophic coverage for the engine, such that when an engine has failed (e.g., cannot run or be easily repaired), the extendable engine service coverage product 10 provides for restoration/rebuilding of the engine. In order to mitigate the risk associated with the potential cost to a qualified service provider for the restoration/rebuilding of a failed engine, according to various aspects, a qualified service provider may enter into an engine assurance agreement with a third party such as, for example, RPM Industries, LLC, where for an agreed upon cost, the third party provides the qualified service provider with reimbursement for parts and labor costs directly incurred due to a failure of an engine covered by the extendable engine service coverage product 10, subject to certain limitations of the engine assurance agreement.

According to various aspects, both new and non-new engines may be eligible for the extendable engine service coverage product 10. For a non-new engine, certain prerequisites may need to be met in order to secure the extendable engine service coverage product 10 for covering the non-new engine. Such prerequisites may include, for example, (1) having the engine inspected by a qualified service provider to determine whether the engine is in good working condition, (2) having a qualified service provider verify whether the engine meets certain age, usage and other pre-determined criteria, and (3) having a qualified service provider verify the engine has received recommended maintenance in accordance with the standard engine warranty 12 and/or the requirements set forth in an applicable qualified maintenance agreement (a qualified maintenance agreement utilized for the same machine when new). To account for the increased risk associated with a non-new machine, the cost associated with a given coverage period of the extendable engine service coverage product 10 for a non-new machine may be higher than the cost associated with a given coverage period of the extendable engine service coverage product 10 for a similar new machine. According to various aspects, the inspection of the non-new engine may be performed in accordance with X-PERT inspection and fluid removal and replacement services provided by RPM Industries, LLC.

The post standard engine warranty service coverage 16 comes into force at the end of the standard engine warranty 12 (or for cases where a non-new engine outside the term of the standard engine warranty 12 is granted coverage under the extendable engine service coverage product 10, upon the generation and creation of the post standard engine warranty service coverage 16). There is no direct cost to the customer for the post standard engine warranty service coverage 16. Rather, the costs incurred by the qualified service provider for providing the post standard engine warranty service coverage 16 are factored into the cost charged by the qualified service provider for the qualified maintenance agreement 22. According to various aspects, the extendable engine service coverage product 10, and by extension, the post standard engine warranty service coverage 16 is provided in increments such as time (e.g., one year), hours (e.g., two thousand hours) of engine operation, and/or miles driven which align/correspond with the increments associated with the qualified maintenance agreement 22. For such aspects, the payment in full of the annual fee for the qualified maintenance agreement 22 prior to the start of a given interval operates to provide the customer with the coverage provided by the extendable engine service coverage product 10 and/or the post standard engine warranty service coverage 16 during the given interval. As long as the cost for the qualified maintenance agreement 22 for a given interval has been timely paid and the criteria set forth in the qualified maintenance agreement 22 is being met, the qualified maintenance agreement 22, and by extension, the extendable engine service coverage product 10 and/or the post standard engine warranty service coverage 16, may be extended for a subsequent interval multiple times up to an overall hours limit (e.g., 20,000 hours) of engine operation, an overall time limit (e.g., 10 years after the purchase/delivery of the machine), an overall miles driven limit, or a combination thereof.

According to various aspects, the cost for a given interval of the qualified maintenance agreement 22 is to be paid in full prior to the expiration of the current interval of the qualified maintenance agreement 22, and assuming all of the conditions of the qualified maintenance agreement 22 are being met, the qualified maintenance agreement 22, and by extension, the extendable engine service coverage product 10 and/or the post standard engine warranty service coverage 16, automatically renews for an additional one year interval with the payment of the annual fee for the qualified maintenance agreement 12. For intervals which are set for a term in excess of one year (e.g., two years), the cost charged for the qualified maintenance agreement 22 may be apportioned between the years, with the customer only having to pay the cost of the qualified maintenance agreement 22 for one year at a time.

According to various aspects, the qualified maintenance agreement 22 may be structured such that the annual fee is the same for every interval. According to other aspects, the qualified maintenance agreement 22 may be structured such that the annual fee for a first given interval may be different from the annual fee for a second given interval to allow for each annual fee to more accurately reflect the costs anticipated to be incurred by the qualified service providers to provide the services set forth in the qualified maintenance agreement 22 and/or the costs incurred for providing the post standard engine warranty service coverage 16. The total cost of the extendable engine service coverage product 10 to the customer is the cost of the qualified maintenance agreement 22 and the cost of any repairs recommended by the qualified service provider to keep the machine in good working order.

The extendable engine service coverage product 10 is fully transferable from owner to owner, any may be transferred multiple times to any number of different owners, as long as the engine remains enrolled in the qualified maintenance agreement 22 and the terms and conditions of the qualified maintenance agreement 22 are being met (subject to overall time limitations, overall hours limitations and/or overall miles driven limitations as described above). Of course, the coverage provided by the extended engine service coverage product 10 and/or the post standard engine warranty service coverage 16 may be terminated by the customer at any time.

In view of the above, it will be appreciated that the extendable engine service coverage product 10 operates to reward an annual commitment by the customer to a qualified maintenance agreement 22 provided by a qualified service provider, and allows for the incremental payment for such coverage on an annual basis as opposed to having to pay an upfront multiyear fee for the full term of the extended engine coverage. The extendable engine service coverage product 10 also extends the overall duration of the engine coverage well beyond the time limit, the hours limit and/or the miles driven limit typically available in today's extended engine warranties. Additionally, the extendable engine service coverage product 10 is available for both new and non-new machines, and is fully transferable from one owner of the machine to any number of subsequent owners of the machine. Furthermore, by effectively bundling the catastrophic coverage into the qualified maintenance agreements 22, the extendable engine service coverage product 10 eliminates the need for the current extended engine warranties, and the relatively expensive, front end heavy, limited duration, non-transferable and/or new machine only shortcomings associated with the current extended engine warranties.

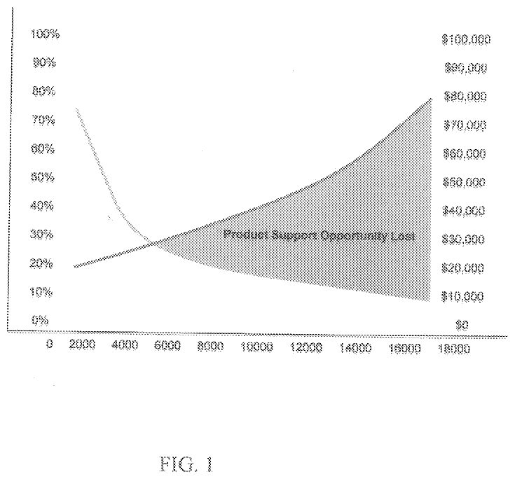

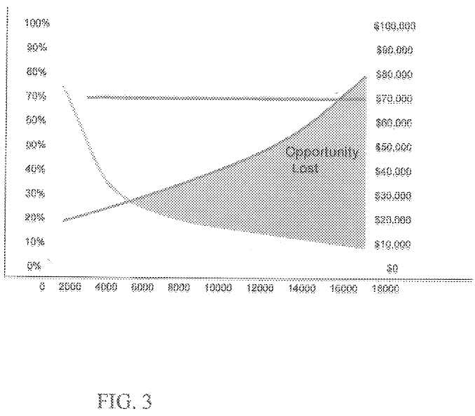

FIG. 3 illustrates a graph 30 showing the graph of FIG. 1 with a horizontal line 32 added thereto, in accordance with at least one aspect of the present disclosure. In FIG. 3 the historic qualified maintenance agreement penetration curve is identified by the reference numeral 34, and the product support aftermarket opportunity curve is identified by the reference numeral 36. As set forth above, the post standard engine warranty service coverage 16 is tied to and included in the cost of the qualified maintenance agreement 22 offered by the qualified service provider, and there is no direct cost to the customer for the post standard engine warranty service coverage 16. The cost for the post standard engine warranty service coverage 16 is borne by the qualified service provider and is factored into the cost for the qualified maintenance agreement 22. An incentive for the qualified service provider to do this is to secure an increased rate of renewal of the qualified maintenance agreements 22, so as to reach a level of qualified maintenance agreement penetration which stabilizes at approximately 50% to 70% of the market, a level which is significantly greater than the 8%-10% penetration currently realized by qualified service providers. The horizontal line 32 in FIG. 3 is representative of a target penetration of approximately 70% for the extendable engine service coverage product 10, which includes the qualified maintenance agreement 22. By realizing an increased level of qualified maintenance agreement penetration, qualified service providers will be able to retain engagement with both the customer and the machine through the high opportunity period, from approximately 5,000 hours to 20,000 hours of engine operation, thereby increasing the likelihood of realizing additional revenue and profit.

Additionally, it is possible the qualified maintenance agreements 22 can be utilized to eliminate the need for the traditional extended engine warranties currently offered. Since the qualified service providers are offering the post standard engine warranty service coverage 16 as part of the qualified service agreement 22, and since the qualified service providers will be engaged more consistently with the customers and the machines for longer periods of time, the qualified service providers, including the distributors/dealers, will be positioned to secure a larger share of the revenue associated with the product support opportunity lost area (shown as a shaded area in FIG. 3).

By utilizing the extendable engine service coverage product 10, customers can eliminate the need for express extended engine warranties, utilize the funding currently spent for such extended engine warranties to fund a qualified maintenance agreement 22 which covers the routine maintenance customers are currently incurring as part of their responsibility, and afford customers the option to shift cost from today's extended engine warranties and such routine maintenance, to solely maintenance required with the qualified maintenance agreement 22, while securing similar benefits. For example, whereas the cost for a current three year/6,000 hour extended engine warranty is approximately $15,000 to $24,000, and the current manufacturer recommended maintenance costs are approximately $5,000-$12,000 per year, the $15,000 $24,000 extended engine warranty can be replaced with a $20,000 three year qualified maintenance agreement which incorporates the post standard engine warranty service coverage 16 therein (where the costs incurred by the qualified service provider to provide the coverage associated with the post standard engine warranty service coverage 16 are approximately $500 per year). The customer can supplant/replace today's extended engine warranties with a qualified maintenance agreement 22 which has a cost which is the same as or less than the cost of today's extended engine warranties for the period covered by today's extended engine warranties, all while adding added catastrophic engine coverage provided by the qualified maintenance agreement 22.

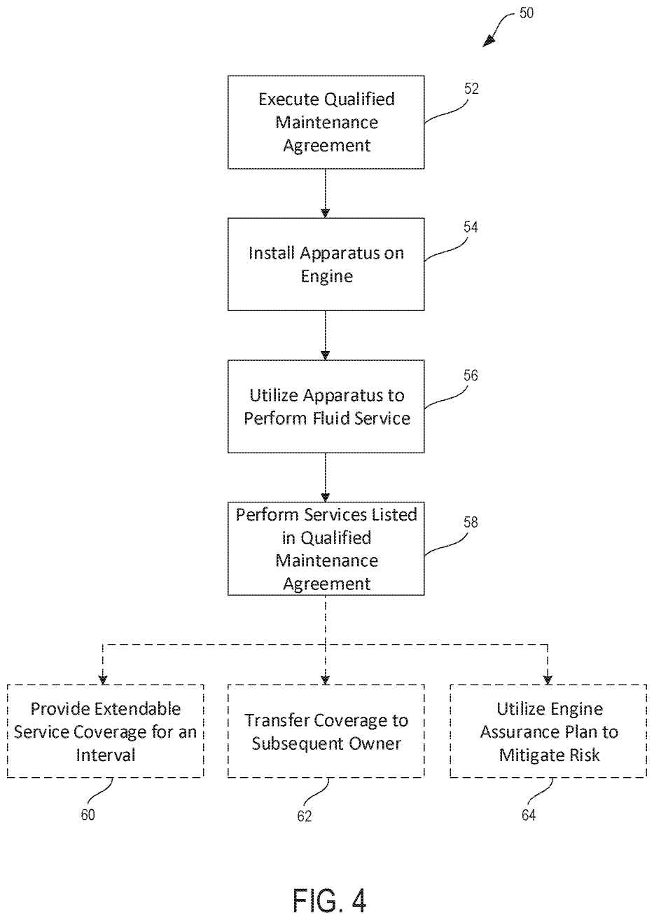

FIG. 4 illustrates a method 50 of providing extendable service coverage for an engine of a machine, in accordance with at least one aspect of the present disclosure. The method 50 may be utilized by a qualified service provider to implement the extendable engine service coverage product 10 described hereinabove. The method 50 includes executing 52 a qualified maintenance agreement such as, for example, the qualified maintenance agreement 22. The qualified maintenance agreement 22 may be executed by a qualified service provider, and the qualified service provider may be a manufacturer of the engine or the machine, a distributor of the engine or the machine, or a dealer of the engine or the machine.

The method 50 also includes installing 54 an apparatus on the engine, where such an apparatus may include, for example, a QuickFit apparatus, a QuickEvac apparatus, a MultiVac apparatus as described above or a similar apparatus. The method further includes utilizing 56 the apparatus to perform a fluid service associated with the engine, where the performance of the fluid service comprises utilizing the apparatus to perform at least one of the following on the engine: a purge of a first fluid from a filter of the engine; an evacuation of a second fluid from the engine; and a refill of a third fluid into the engine. The first, second and/or third fluids can be one or more of the following: an engine oil; a transmission fluid; a hydraulic fluid; and an engine coolant. The method additionally includes performing 58 all services listed in the qualified maintenance agreement.

According to various aspects, the method 50 may optionally further include (1) providing 60 the extendable service coverage for the engine for an interval corresponding to at least one of the following: a period of time; hours of operation of the engine; and miles driven by a vehicle associated with the engine, (2) transferring 62 the extendable service coverage from one owner of the engine/machine to a subsequent owner of the engine/machine and/or (3) utilizing 64 an engine assurance plan to mitigate a risk associated with a catastrophic engine coverage provided by the extendable service coverage.

Although the method 50 is shown as being implemented in a particular order, it will be appreciated that at least some of the steps may be performed concurrently and/or in a different sequence. For example, the executing 52 and the installing 54 may be performed concurrently, or the installing 54 may be performed before the executing 52.

### EXAMPLES

Example 1—An extendable engine service coverage product is provided. The extendable engine service coverage product comprises a standard engine warranty for an engine of a machine, additional obligations and a post standard engine warranty service coverage for the engine of the machine. The additional obligations comprise customer obligations, qualified service provider obligations, and a qualified maintenance agreement.

Example 2—The extendable engine service coverage product of Example 1, wherein the customer obligations comprise (1) a customer executing the qualified maintenance agreement with a qualified service provider and (2) having all repairs recommended by the qualified service provider to keep the engine of the machine in good working order completed.

Example 3—The extendable engine service product of Examples 1 or 2, wherein the qualified service provider obligations comprise (1) certifying the engine of the machine is eligible for the extendable engine service coverage product and (2) performing a service on the engine of the machine required by the qualified maintenance agreement.

Example 4—The extendable engine service product of Example 3, wherein the qualified service provider obligations further comprise (1) installing an apparatus on the engine of the machine and (2) utilizing the apparatus to perform the service on the engine of the machine.

Example 5—The extendable engine service product of Example 4, wherein the apparatus comprises a valve assembly.

Example 6—The extendable engine service product of Examples 4 or 5, wherein the apparatus comprises a motor and a pump.

Example 7—The extendable engine service product of Example 6, wherein the motor and the pump form a motor and pump assembly.

Example 8—The extendable engine service product of Examples 4, 5, 6 or 7, wherein the apparatus comprises a service tool configured to facilitate evacuation of a fluid from the engine of the machine.

Example 9—The extendable engine service product of Examples 4, 5, 6, 7, 8 or 9, wherein the apparatus comprises a service tool configured to facilitate evacuation of a fluid from the engine of the machine.

Example 10—The extendable engine service product of Example 9, wherein the motor and the pump form a motor and pump assembly.

Example 11—A method of providing extendable service coverage for an engine of a machine is provided. The method comprises executing a qualified maintenance agreement, installing an apparatus on the engine, utilizing the apparatus to perform a fluid service associated with the engine, and performing all services listed in the qualified maintenance agreement.

Example 12—The method of Example 11, wherein executing the qualified maintenance agreement comprises a qualified service provider executing the qualified maintenance agreement.

Example 13—The method of Example 12, wherein executing the qualified maintenance agreement further comprises one of the following executing the qualified maintenance agreement (1) a manufacturer of the engine or the machine, (2) a distributor of the engine or the machine, and (3) a dealer of the engine or the machine.

Example 14—The method of Examples 11, 12 or 13, wherein installing an apparatus on the engine comprises installing at least one of the following on the engine (1) a valve assembly, (2) a motor, and (3) a pump.

Example 15—The method of Examples 11, 12, 13 or 14, wherein utilizing the apparatus to perform a fluid service associated with the engine comprises utilizing the apparatus to perform at least one of the following on the engine (1) a purge of a first fluid from a filter of the engine, (2) an evacuation of a second fluid from the engine, and (3) a refill of a third fluid into the engine.

Example 16—The method of Example 15, wherein evacuating the second fluid comprises evacuating one of the following from the engine: (1) an engine oil, (2) a transmission fluid, (3) a hydraulic fluid, and (4) an engine coolant.

Example 17—The method of Example 11, 12, 13, 14, 15 or 16, further comprising providing the extendable service coverage for the engine for an interval corresponding to at least one of the following (1) a period of time, (2) hours of operation of the engine, and (3) miles driven by a vehicle associated with the engine.

Example 18—The method of Example 17, further comprising extending the extendable service coverage for the engine for an additional interval.

Example 19—The method of Examples 11, 12, 13, 14, 15, 16, 17 or 18, further comprising transferring the extendable service coverage from one owner of the machine to a subsequent owner of the machine

Example 20—The method of Examples 11, 12, 13, 14, 15, 16, 17, 18 or 19, further comprising utilizing an engine assurance plan to mitigate a risk associated with a catastrophic engine coverage provided by the extendable service coverage.

Although the various aspects of the extendable engine service coverage product 10 and method 50 have been described herein in connection with certain disclosed aspects, many modifications and variations to those aspects may be implemented. Also, where materials are disclosed for certain components, other materials may be used. Furthermore, according to various aspects, a single component may be replaced by multiple components, and multiple components may be replaced by a single component, to perform a given function or functions. The foregoing description and the appended claims are intended to cover all such modifications and variations as falling within the scope of the disclosed aspects.

While this invention has been described as having exemplary designs, the described invention may be further modified within the spirit and scope of the disclosure. This application is therefore intended to cover any variations, uses, or adaptations of the invention using its general principles. For example, although the invention was described in the context of an extendable engine service coverage product 10 for an earth-moving machine, the general principles of the invention are equally applicable to other types of extendable engine service coverages for other types of machines such as, for example, mobile generators, marine vessels, over-the-road vehicles, etc.

Any patent, patent application, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A system configured to extend the life of a machine, comprising:
a plurality of fluid systems of the machine;
a fluid service apparatus configured to be connected to each of the plurality of fluid systems of the machine, wherein the fluid service apparatus is configured to:
perform a maintenance operation on the machine, wherein the maintenance operation comprises removing a first fluid from a first system of the plurality of fluid systems and introducing a second fluid into a second system of the plurality of fluid systems; and
automatically document performance of the maintenance operation, wherein the documented performance of the maintenance operation certifies that the life of the machine has been extended via the performance of the maintenance operation.

2. The system of claim 1, wherein the fluid service apparatus comprises a closed loop system configured to reduce spills, dripping filters, and without drain pans or intermediate containers.

3. The system of claim 1, wherein the fluid service apparatus is configured to perform the maintenance operation on each fluid system of the plurality of fluid systems in less than ten minutes per system.

4. The system of claim 1, wherein the fluid service apparatus comprises an onboard motor and pump.

5. The system of claim 4, wherein the onboard motor and pump are self-contained.

6. The system of claim 1, wherein the fluid service apparatus comprises service tools configured to facilitate an evacuation of fluid from each system of the plurality of fluid systems.

7. The system of claim 1, wherein plurality of fluid systems comprises an oil system, a transmission fluid system, a hydraulic fluid system, and an engine coolant system.

8. The system of claim 7, wherein the fluid service apparatus comprises a plurality of fittings, wherein each fitting of the plurality of fittings, wherein each fitting of the plurality of fittings is configured to correspond to a fluid system of the plurality of fluid systems, and wherein each fitting of the plurality of fittings is configured to manage a fluid contained within the corresponding fluid system of the plurality of fluid systems.

9. The system of claim 7, wherein the fluid service apparatus comprises a multiple selector valve assembly configured to service each fluid system of the plurality of fluid systems.

10. The system of claim 1, wherein wherein the documented performance of the maintenance operation certifies an engine of the machine for restoration in view of a catastrophic failure in which the engine can no longer run.

11. The system of claim 1, wherein automatically documenting performance of the maintenance operation comprises generating a timestamp.

12. The system of claim 1, wherein the fluid service apparatus is configured to reduce burns and spills during the maintenance operation.

13. A system configured to extend the life of a machine, comprising:
a fluid service apparatus configured to be connected to a plurality of compartments of the machine, wherein the fluid service apparatus is configured to:
perform a maintenance operation on the machine, wherein the maintenance operation comprises removing a first fluid from a first system of the plurality of compartments and introducing a second fluid into a second system of the plurality of compartments; and
automatically document performance of the maintenance operation, wherein the documented performance of the maintenance operation certifies that the life of the machine has been extended via the performance of the maintenance operation.

14. The system of claim 13, wherein the fluid service apparatus comprises a closed loop system configured to reduce spills, dripping filters, and without drain pans or intermediate containers.

15. The system of claim 13, wherein the fluid service apparatus is configured to perform the maintenance operation on each system of the plurality of compartments in less than ten minutes per compartment.

16. The system of claim 13, wherein the fluid service apparatus comprises a multiple selector valve assembly configured to service the machine at a remote location relative to a service facility.

17. The system of claim 13, wherein wherein the documented performance of the maintenance operation certifies an engine of the machine for restoration in view of a catastrophic failure in which the engine can no longer run.

18. A method of verifying performance of a machine fluid service operation comprising:
coupling a fluid service apparatus to a machine;
removing, via the fluid service apparatus, operational fluid from a first compartment of the machine;
introducing, via the fluid service apparatus, replacement fluid into a second compartment of the machine;
automatically generating, via the fluid service apparatus, documentation verifying completion of the removal of the operational fluid and the introduction of the replacement fluid; and
maintaining records of preventative maintenance actions performed on the machine, wherein the records comprise the documentation verifying completion of the removal of the operational fluid and the introduction of the replacement fluid, wherein including based on the generated documentation, and wherein the records certify that the life of the machine has been extended.

19. The method of claim 18, wherein the fluid service apparatus comprises a closed loop system configured to reduce spills, dripping filters, and without drain pans or intermediate containers.

20. The method of claim 18, wherein the fluid service apparatus is configured to remove the operational fluid from the first compartment in less than ten minutes, and wherein the fluid service apparatus is configured to introduce the replacement fluid into the second compartment in less than ten minutes.

21. The method of claim 18, wherein automatically generating documentation verifying completion of the removal of the operational fluid and the introduction of the replacement fluid comprises generating a timestamp.
